(19) United States
(12) Patent Application Publication
(10) Pub. No.: US 2026/0268239 A1
(43) Pub. Date: Sep. 10, 2026

(54) LOW POWER SYSTEM AND METHOD FOR TIME SERIES FORECASTING AN ASSET

(71) Applicant: JPMorgan Chase Bank, N.A., New York, NY (US)

(72) Inventors: Grant CHANG, Fresh Meadows, NY (US); Leonard EUN, Lafayette, CA (US); Amit VARSHNEY, Fremont, CA (US); Xiaotao Wu, West Windsor, NJ (US); Shuo Chen, New York, NY (US); Georgiy Zhikharev, Englewood Cliffs, NJ (US); Gaurav Yadav, Karnataka (IN); Yong Tian, Holmdel, NJ (US); Zili Weng, North Brunswick, NJ (US)

(73) Assignee: JPMorgan Chase Bank, N.A., New York, NY (US)

(21) Appl. No.: 19/073,918

(22) Filed: Mar. 7, 2025

(51) Int. Cl. G06Q 10/04; G06Q 40/06

(52) U.S. Cl. CPC G06Q 10/04; G06Q 40/06

(57) ABSTRACT

A methodology for forecasting an asset's volatility based on a low number of factors The methodology may include identifying a factor subset of a total factor set, including: preselecting factors from the total factor set based on known attributes of the asset; determining exposure for each of the preselected factors, the exposures defining an influence of each of the preselected factors on performance of the asset; pruning factors for which the determined exposures fail to satisfy predetermined criteria; adding other factors, from the total factor set to the factor subset, that improve performance of the asset. In addition, the methodology may include first applying temporal cross validation to at least the factor subset, second applying dynamic conditional correlation to factor returns of the total factor set, and forecasting the asset's volatility based on results of the first applying and the second applying.

### TECHNICAL FIELD

This disclosure relates to methods and apparatuses to generate accurate time series forecasts for an asset using minimal features to reduce use of computer resources and electrical power consumption.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Forecasting risk and alpha through factor-based analytics serves as an integral part of risk control and portfolio management. Factor models offer a parsimonious framework to identify and assess the drivers of risk in portfolios. These models provide an alternative lens to complement other methods to provide a better understanding of risk. Therefore, the purpose behind a well-constructed factor model is to measure volatility, examine whether risks are distributed uniformly, identify intended and unintended bets, or determine how exposures deviate from their benchmarks. In the field of time series forecasts, a wide array of robust and well-established models have been developed to assess risk and generate accurate predictions, particularly when dealing with deterministic data.

In the field of risk modeling, traditional methods encounter significant challenges stemming from data complexity, the necessity for extensive datasets, the potential of misleading correlations, and the inherent limitations of historical data. Although modern computing can manage many of these calculations, obtaining statistically robust estimates often demands comprehensive historical data, which may not always be accessible. Additionally, correlations can be deceptive; simultaneous downturns in unrelated industries may produce spurious correlations that lack economic rationale, resulting in unstable estimates. To mitigate these problems, random sampling techniques can be used to discern authentic relationships or generate the necessary data.

A technical problem with the traditional approaches is they rely on a large number of factors, and thus a massive number of combinations of factors, in making each forecast and therefore consume a great deal of computing resources and corresponding electrical power, and take a long time to process. Electrical power demands for such operations are an industry wide problem, as illustrated by Microsoft recently leasing a nuclear power plant to provide electricity for its data processing operations. There is a need for a forecast methodology that can provide accuracy with lower electrical power and computer processing requirements, and which can provide results in less time.

### SUMMARY

The present disclosure, through one or more of its various aspects, embodiments, and/or specific features or sub-components, provides, among other features, various systems, servers, devices, methods, media, programs, and platforms for generating accurate time series forecasts for an asset using minimal features to reduce use of computer resources and electrical power consumption.

According to an aspect of the present disclosure, a method for forecasting an asset's volatility based on a low number of factors is provided. The method may include identifying a factor subset of a total factor set, including: preselecting factors from the total factor set based on known attributes of the asset; determining exposure for each of the preselected factors, the exposures defining an influence of each of the preselected factors on performance of the asset; pruning factors for which the determined exposures fail to satisfy first predetermined criteria; adding other factors, from the total factor set to the factor subset, that improve performance of the asset. In addition, the method may include first applying temporal cross validation to at least the factor subset, second applying dynamic conditional correlation to factor returns of the total factor set, and forecasting the asset's volatility based on results of the first applying and the second applying.

The above method may include various optional features. Determining exposures for each of the preselected factors may include applying ordinary least squares (OLS) regression on the preselected factors to indicate which of the preselected factors have the strongest relationship with performance of the asset. The adding may include: establishing a baseline performance of the factor subset; selecting a new factor from remaining ones of the total factor set; determining whether a performance effect of the new factor relative to the baseline performance meets second predetermined performance criteria; incorporating, in response to at least a positive result of the determining, the new factor into the factor subset; and returning to the selecting until the total factor set is empty. Steps between the incorporating and the returning may include adjusting the baseline performance to account for the performance of the factor subset after the incorporating. The method may include: determining whether results of the identifying are either suboptimal or affected by excessive noise per third predetermined criteria; in response to at least a positive result of the determining: applying ridge regression to evaluate all possible combinations of factors from the total factor set; optimizing a ridge regularization parameter for each combination; and selecting as the factor subset a combination of factors from the total factor set that achieves a highest objective function score. The applying dynamic conditional correlation may include: estimating, for each one of n series of returns, a conditional volatility using a Generalized Autoregressive Conditional Heteroskedasticity model; generating a dynamic conditional correlation matrix for the factor subset based on results of the estimating; and converting the dynamic conditional correlation matrix into a forecasted correlation matrix. The method may include the preselected factors being based on a sector, a size, and a valuation metric of the asset.

According to an aspect of the present disclosure, a system for forecasting an asset's volatility based on a low number of factors is provided. The system includes a processor and a memory storing instructions programmed to cooperate with the processor to cause the processor to perform operations. The operations may include identifying a factor subset of a total factor set, including: preselecting factors from the total factor set based on known attributes of the asset; determining exposure for each of the preselected factors, the exposures defining an influence of each of the preselected factors on performance of the asset; pruning factors for which the determined exposures fail to satisfy first predetermined criteria; adding other factors, from the total factor set to the factor subset, that improve performance of the asset. In addition, the operations may include first applying temporal cross validation to at least the factor subset, second applying dynamic conditional correlation to factor returns of the total factor set, and forecasting the asset's volatility based on results of the first applying and the second applying.

The above system may include various optional features. Determining exposures for each of the preselected factors may include applying ordinary least squares (OLS) regression on the preselected factors to indicate which of the preselected factors have the strongest relationship with performance of the asset. The adding may include: establishing a baseline performance of the factor subset; selecting a new factor from remaining ones of the total factor set; determining whether a performance effect of the new factor relative to the baseline performance meets second predetermined performance criteria; incorporating, in response to at least a positive result of the determining, the new factor into the factor subset; and returning to the selecting until the total factor set is empty. Operations between the incorporating and the returning may include adjusting the baseline performance to account for the performance of the factor subset after the incorporating. The operations may include: determining whether results of the identifying are either suboptimal or affected by excessive noise per third predetermined criteria; in response to at least a positive result of the determining: applying ridge regression to evaluate all possible combinations of factors from the total factor set; optimizing a ridge regularization parameter for each combination; and selecting as the factor subset a combination of factors from the total factor set that achieves a highest objective function score. The applying dynamic conditional correlation may include: estimating, for each one of n series of returns, a conditional volatility using a Generalized Autoregressive Conditional Heteroskedasticity model; generating a dynamic conditional correlation matrix for the factor subset based on results of the estimating; and converting the dynamic conditional correlation matrix into a forecasted correlation matrix. The operations may include the preselected factors being based on a sector, a size, and a valuation metric of the asset.

According to an aspect of the present disclosure, a non-transitory computer readable media storing instructions programmed to cooperate with a processor to cause the processor to perform operations for forecasting an asset's volatility based on a low number of factors is provided. The operations may include identifying a factor subset of a total factor set, including: preselecting factors from the total factor set based on known attributes of the asset; determining exposure for each of the preselected factors, the exposures defining an influence of each of the preselected factors on performance of the asset; pruning factors for which the determined exposures fail to satisfy first predetermined criteria; adding other factors, from the total factor set to the factor subset, that improve performance of the asset. In addition, the operations may include first applying temporal cross validation to at least the factor subset, second applying dynamic conditional correlation to factor returns of the total factor set, and forecasting the asset's volatility based on results of the first applying and the second applying.

The above methodology may include various optional features. Determining exposures for each of the preselected factors may include applying ordinary least squares (OLS) regression on the preselected factors to indicate which of the preselected factors have the strongest relationship with performance of the asset. The adding may include: establishing a baseline performance of the factor subset; selecting a new factor from remaining ones of the total factor set; determining whether a performance effect of the new factor relative to the baseline performance meets second predetermined performance criteria; incorporating, in response to at least a positive result of the determining, the new factor into the factor subset; and returning to the selecting until the total factor set is empty. Operations between the incorporating and the returning may include adjusting the baseline performance to account for the performance of the factor subset after the incorporating. The operations may include: determining whether results of the identifying are either suboptimal or affected by excessive noise per third predetermined criteria; in response to at least a positive result of the determining: applying ridge regression to evaluate all possible combinations of factors from the total factor set; optimizing a ridge regularization parameter for each combination; and selecting as the factor subset a combination of factors from the total factor set that achieves a highest objective function score. The applying dynamic conditional correlation may include: estimating, for each one of n series of returns, a conditional volatility using a Generalized Autoregressive Conditional Heteroskedasticity model; generating a dynamic conditional correlation matrix for the factor subset based on results of the estimating; and converting the dynamic conditional correlation matrix into a forecasted correlation matrix. The operations may include the preselected factors being based on a sector, a size, and a valuation metric of the asset.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using an AI/ML model in accordance with an embodiment.

FIG. 2 illustrates an exemplary diagram of a network environment with a device for using an AI/ML model in accordance with an embodiment.

FIG. 3 illustrates a system diagram for implementing a method for using an AI/ML model in accordance with an embodiment.

FIG. 4 illustrates an exemplary flow chart of a process for generating accurate time series forecasts for an asset using minimal features to reduce use of computer resources and electrical power consumption, in accordance with an embodiment.

FIG. 5 illustrates a model design that corresponds to a process for generating accurate time series forecasts for an asset using minimal features to reduce use of computer resources and electrical power consumption, in accordance with an embodiment.

FIG. 6 illustrates a data flow that corresponds to a process for generating accurate time series forecasts for an asset using minimal features to reduce use of computer resources and electrical power consumption, in accordance with an embodiment.

FIG. 7 illustrates a data flow that corresponds to a process for generating accurate time series forecasts for an asset using minimal features to reduce use of computer resources and electrical power consumption, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

A technical problem with the traditional approaches is they rely on a large number of factors in making each forecast and therefore consume a great deal of computing resources and corresponding electrical power. Electrical power demands for such operations are an industry wide problem, as illustrated by Microsoft recently leasing a nuclear power plant to provide electricity for its data processing operations. There is a need for a forecast methodology that can provide accuracy with lower electrical power and computer processing requirements.

According to an aspect of the present disclosure, a method for forecasting an asset based on a low number of factors is provided. The method may include identifying a factor subset of a total factor set, including: preselecting factors from the total factor set based on known attributes of the asset; determining exposure for each of the preselected factors, the exposures defining an influence of each of the preselected factors on performance of the asset; pruning factors for which the determined exposures fail to satisfy first predetermined criteria; adding other factors, from the total factor set to the factor subset, that improve performance of the asset. In addition, the method may include applying temporal cross validation to at least the factor subset, and applying dynamic conditional correlation based on the temporal cross validation.

The above methodology provides a technical solution that solves the technical electrical power and computer resource problems of the traditional methods by reducing the number of factors that are considered in the forecast to only those factors that are considered to have a measurable significant impact of the performance of the forecast, whereas factors that have little or no influence on performance are not used in the forecasting. This not only reduces the number of factors, but also greatly reduces the number of factor combinations that are considered. By basing the forecast on a lower number of factors, and by extension the lower number of combination of factors, than traditional methods, the forecast uses considerably less computer processing and with reduced overall demand for electrical power compared to traditional methods and provides results faster than traditional methods. For example, considering 30 factors requires consideration of some 1 billion combinations, whereas reducing the factors from 30 to 20 only requires consideration of 1 million combinations, with a corresponding massive savings in computer resources, power, and time of computation.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented.

The terms “substantial”, “substantially” or the like are defined to be essentially conforming to the particular dimension, shape, or other feature that the term modifies, such that the component need not be exact. For example, “substantially cylindrical” means that the object resembles a cylinder, but can have one or more deviations from a true cylinder. The terms are used as a modifier to imply “approximate” rather than “perfect.” It is a term of approximation, not a term of degree.

The term “comprising” when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ±5% may be expected.

“First,” “second,” etc., re labels to distinguish components or blocks of otherwise similar names, but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

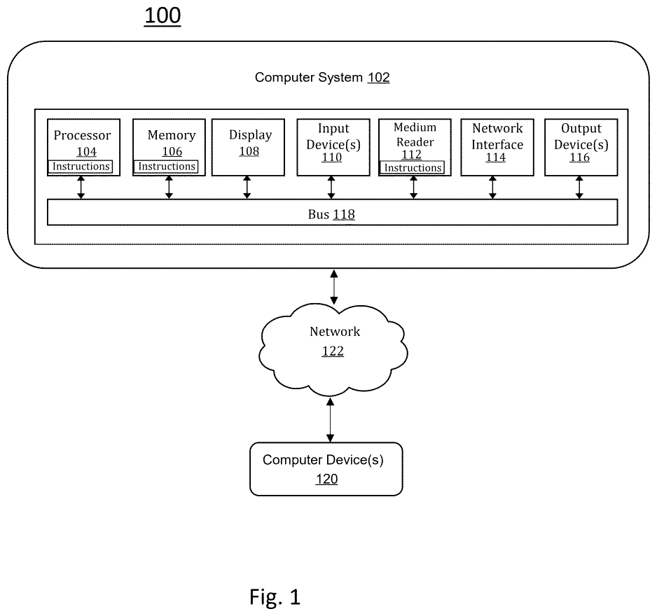

FIG. 1 is an exemplary system 100 for use in implementing a method for using an AI/ML model to generate accurate time series forecasts for an asset using minimal features to reduce use of computer resources and electrical power consumption. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain′t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

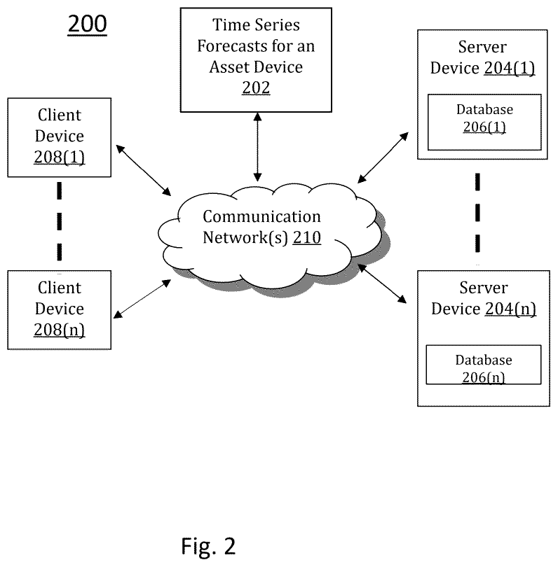

Referring to FIG. 2, a schematic of an exemplary network environment 200 for implementing to generate accurate time series forecasts for an asset device (TSFFAD) 202 using minimal features to reduce use of computer resources and electrical power consumption.

In some embodiments, the above-described problems associated with conventional tools may be overcome by implementing an TSFFAD 202 as illustrated in FIG. 2 that may be configured for implementing a method for using an AI/ML forecasting model to perform to generate accurate time series forecasts for an asset device (TSFFAD) using minimal features to reduce use of computer resources and electrical power consumption. but the disclosure is not limited thereto.

The TSFFAD 202 may have one or more computer system 102s, as described with respect to FIG. 1, which in aggregate provide the necessary functions.

The TSFFAD 202 may store one or more applications that can include executable instructions that, when executed by the TSFFAD 202, cause the TSFFAD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the TSFFAD 202 itself, may be located in virtual server(s) running in a cloud-based computing environment rather than being tied to one or more specific physical network computing devices. Also, the application(s) may be running in one or more virtual machines (VMs) executing on the TSFFAD 202. Additionally, in one or more embodiments of this technology, virtual machine(s) running on the TSFFAD 202 may be managed or supervised by a hypervisor.

In the network environment 200 of FIG. 2, the TSFFAD 202 is coupled to a plurality of server devices 204(1)-204(n) that hosts a plurality of databases 206(1)-206(n), and also to a plurality of client devices 208(1)-208(n) via communication network(s) 210. A communication interface of the TSFFAD 202, such as the network interface 114 of the computer system 102 of FIG. 1, operatively couples and communicates between the TSFFAD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TSFFAD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The TSFFAD 202 may be a standalone device or integrated with one or more other devices or apparatuses, such as one or more of the server devices 204(1)-204(n), for example. In one particular example, the TSFFAD 202 may be hosted by one of the server devices 204(1)-204(n), and other arrangements are also possible. Moreover, one or more of the devices of the TSFFAD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the TSFFAD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the TSFFAD 202 that may efficiently provide a platform for implementing a method for using an AI/ML model to generate accurate time series forecasts using minimal features to reduce use of computer resources and electrical power consumption, but the disclosure is not limited thereto.

The client devices 208(1)-208(n) may run interface applications, such as standard web browsers or standalone client applications, which may provide an interface to communicate with the TSFFAD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the TSFFAD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the TSFFAD 202, the server devices 204(1)-204(n), or the client devices 208(1)-208(n), for example, may be configured to operate as virtual instances on the same physical machine. For example, one or more of the TSFFAD 202, the server devices 204(1)-204(n), or the client devices 208(1)-208(n) may operate on the same physical device rather than as separate devices communicating through communication network(s) 210. Additionally, there may be more or fewer TSFFADs 202, server devices 204(1)-204(n), or client devices 208(1)-208(n) than illustrated in FIG. 2. In some embodiments, the TSFFAD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

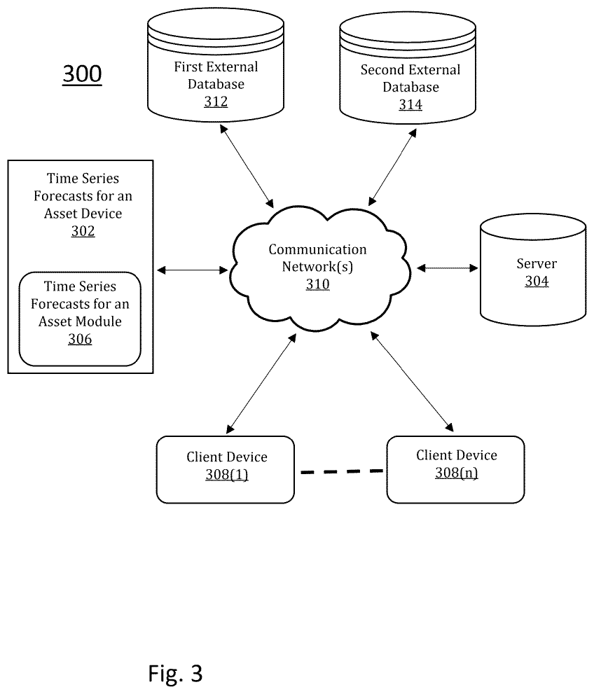

FIG. 3 illustrates a system diagram for implementing an TSFFAD 302 having time series forecasts for an asset module (TSFFAM), in accordance with an embodiment.

As illustrated in FIG. 3, the system 300 may include an TSFFAD 302 within which an TSFFAM 306 is embedded, a server 304, a first external database 312, a second external database 314, a plurality of client devices 308(1) . . . 308(n), and a communication network 310.

In some embodiments, the TSFFAD 302 including the TSFFAM 306 may be connected to the server 304, and the database(s) 312 via the communication network 310. The TSFFAD 302 may also be connected to the plurality of client devices 308(1) . . . 308(n) via the communication network 310, but the disclosure is not limited thereto.

In an embodiment, the TSFFAD 302 is described and shown in FIG. 3 as including the TSFFAM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the TSFFAM 306 may be configured to receive real-time feed of data from the plurality of client devices 308(1) . . . 308(n) and secondary sources via the communication network 310.

The plurality of client devices 308(1) . . . 308(n) are illustrated as being in communication with the TSFFAD 302. In this regard, the plurality of client devices 308(1) 308(n) may be “clients” (e.g., customers) of the TSFFAD 302 and are described herein as such. Nevertheless, it is to be known and understood that the plurality of client devices 308(1) . . . 308(n) need not necessarily be “clients” of the TSFFAD 302, or any entity described in association therewith herein. Any additional or alternative relationship may exist between either or both of the plurality of client devices 308(1) . . . 308(n) and the TSFFAD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the TSFFAD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The TSFFAD 302 may be the same or similar to the TSFFAD 202 as described with respect to FIG. 2, including any features or combination of features described with respect thereto.

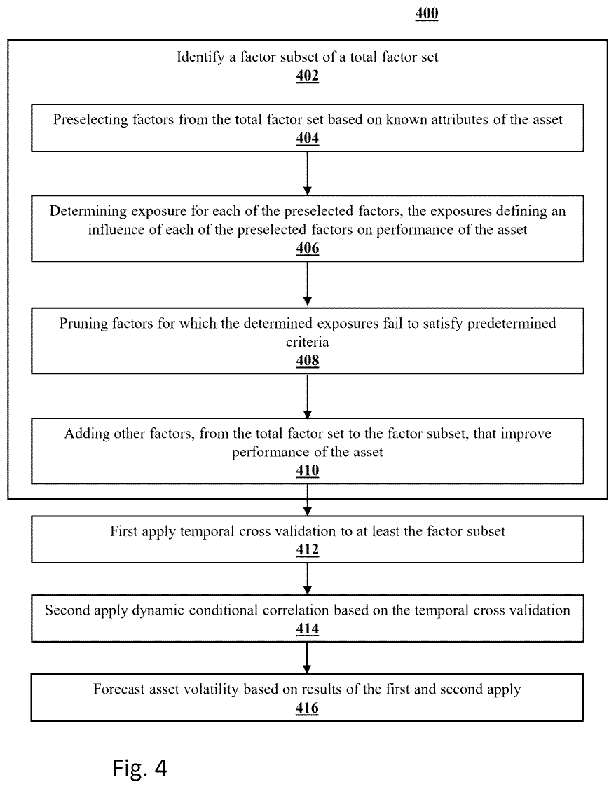

FIG. 4 illustrates an exemplary flow chart of a process 400 implemented by the TSFFAM 306 of FIG. 3 for enablement of a system and a method for using an AI/ML model to perform the noted operations, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include identifying a factor subset of a total factor set.

Step 402 may include sub steps, including: at step 404 preselecting factors from the total factor set based on known attributes of the asset; at step 406 determining exposure for each of the preselected factors, the exposures defining an influence of each of the preselected factors on performance of the asset; at step 408 pruning factors for which the determined exposures fail to satisfy predetermined criteria; and at step 410 adding other factors, from the total factor set to the factor subset, that improve performance of the asset.

The process may include a step 412 of first applying temporal cross validation to at least the factor subset.

The process may include a step 414 of second applying dynamic conditional correlation to factor returns of the total factor set.

The process may include a step 416 of forecasting the asset's volatility based on results of the first applying and the second applying.

The above methodology provides a technical solution that solves the technical electrical power and computer resource problems of the traditional methods by reducing the number of factors that are considered in the forecast to only those factors that are considered to have a measurable significant impact of the performance of the forecast, whereas factors that have little or no influence on performance are not used in the forecasting. This not only reduces the number of factors, but also greatly reduces the number of combination of factors that must be considered. By basing the forecast on a lower number of factors, and by extension the lower number of combination of factors, than traditional methods, the forecast uses less computer processing and with reduced overall demand for electrical power compared to traditional methods, and provides results faster than traditional methods. For example, considering 30 factors requires consideration of some 1 billion combinations, whereas reducing the factors from 30 to 20 only requires consideration of 1 million combinations, with a corresponding massive savings in computer resources, power, and time of computation.

According to an embodiment, the methodology includes three overall steps: employing advanced factor selection techniques and robust data processing, capturing transient factor signals and time-varying asset exposures through temporal cross-validation, and enhancing the accuracy of correlation estimates by incorporating dynamic conditional correlation.

The first overall step in this process is factor selection, performed by a machine learning model or AI (hereinafter simply “model”) previously trained to perform the steps as disclosed below. The goal of factor selection is to identify a subset of a total factor set that is relevant to explaining the realized return on the assets. This methodology thus focuses on the most influential factors that drive asset while ignoring factors that have little to no influence. By reducing the number of factors considered to only those that are most relevant, and greatly reducing the need to evaluate all possible combinations of them, the subsequent processing uses less computing processing power and less electrical power than traditional methodologies that rely upon larger factor sets. A total factor set may include 32 factors, but the invention is not limited to any particular factor set.

The factor selection process includes three stages. In the first stage, the previously trained model preselects factors from the total factor set based on the various known attributes of the assets to be forecast, such as their sector, size, and valuation metrics.

The stage of this methodology may begin by examining the intrinsic attributes of the asset, such as its geographical region and sector classification. These attributes provide a foundational understanding of the asset's potential behavior and risk profile. By analyzing these characteristics, a previously trained model can compute the asset's exposures to relevant factors that are typically associated with its region and sector.

For funds and indices, determining these exposures can be directly inferred from the constituent securities that make up the fund or index. Aggregating the factor exposures of these individual securities provides a comprehensive picture of the overall factor exposures for the fund or index. This aggregation process captures the collective influence of the underlying securities on the fund or index's performance.

For single-named securities, the process may require a more nuanced and detailed analysis. This is because single securities are influenced by a variety of factors specific to their business operations, competitive environment, and market positioning. The model therefore examines the business, including its financial statements, market strategy, and industry dynamics, to accurately assess its factor exposures.

From the calculated factor exposures, the model preselects those factors with exposures exceeding certain predefined thresholds. These thresholds may be set based on historical data and expert judgment, ensuring that only the most significant factors are considered for further analysis. This preselection process helps to filter out noise and focus on the factors that are most likely to drive asset returns.

In addition to the quantitative analysis, the methodology can employ natural language processing (NLP) techniques to analyze text data associated with the asset. This includes company reports, news articles, and other relevant documents. By processing this text data, the model can identify additional factors that may not be immediately apparent through traditional quantitative methods. NLP can reveal insights from qualitative information, such as market sentiment, management commentary, and emerging trends, which can provide valuable context for factor selection.

In some cases, the above methodology yields zero preselected factors. In response to at least that circumstance, the methodology considers the total factor set as preselected factors. This ensures the methodology does not overlook any factors that could be relevant, even if they are not immediately apparent through the methodology above.

Once the methodology arrives at the set of preselected factors, the next stage is to prune the set to identify only most relevant factors. The model applies ordinary least squares (OLS) regression to the set of preselected factors, which may identify which factors have the strongest relationship with the asset's performance.

The methodology is looking for a so-called “p-value” for each preselected factor. The p-value shows how likely it is that a particular factor's effect on the asset's return is due to chance. If a preselected factor's p-value is higher than a predetermined threshold, then the factor is considered to have insufficient influence on performance to justify its inclusion in the further processing, and so the methodology prunes that factor from the set of preselected factors. This methodology applies to all of the preselected factors until all the remaining factors have p-values below the threshold, indicating they are likely to be significant.

After the pruning, the total factor set will include those factors that have been selected to date (having gone through preselection and survived pruning), and the remaining ones of the total factor set (which were either not preselected or were preselected and then pruned). It may be possible that some of the remaining ones of the total factor set are still relevant. The third stage identifies and adds back in any relevant factors from the total factor set.

The methodology applies k-fold cross-validation, which divides the performance data into several parts and tests how well the factors so far predict asset returns on each part. This provides a baseline performance score that indicates how well the current set of factors is performing.

The methodology then individually tests each of the remaining factors relative to the baseline. Each potential new factor is added to the existing set of factors to see how it performs using the same regression method. If it seems promising relative to predetermined criteria (e.g., p value is above 0.05), the methodology performs the k-fold cross-validation again, this time including the new factor. The methodology compares the results to the current baseline, such as by using a statistical test called the Wilcoxon test. This test determines if the new factor improves the model's performance in a statistically significant way relative to predetermined criteria (e.g. >0.5% improvement).

If the new factor shows a significant improvement relative to predefined criteria, the methodology adds it to the list of selected factors and updates the baseline performance score.

The methodology repeats this process for all of the remaining factors of the total factor set.

By employing this methodology, the carefully chosen limited set of factors effectively models the behavior of a vast array of assets. Utilizing information that reflects the last known state of an asset helps mitigate some of the previous challenges and provides a more robust solution. By focusing on a limited number of factors rather than a multitude of factors, the methodology significantly reduces the number of correlations that need to be estimated, which reduces the strain on computer resources and reduces the corresponding demand for electrical power.

A non-limiting example of high-level pseudocode outlining the proposed methodology is presented below:

```
def factor_selection(v):
  # Rule-based
  v = Vehicle(vehicle_id)
  ***
  v.exposure = v.get_exposure_based_on_attributes( )
  preselected_factors = [f for f in factors if v.exposure[f] > threshold]
  # load additional factors based on a natural language processing model
  if len(preselected_factors) == 0:
    preselected factors = load_factors_by_nlp(v.security_name,
```

factor_dictionary)

```
    ***
  # pre-load all factors if nothing has been selected
  if len(preselected_factors) == 0:
    preselected_factors = factors
  ***
  # Data-driven
  def select_factors_based_on_pval(v, factors, pval):
    while True:
      pvals = ols_with_constant(v, factors)
      if (pvals > 0.05).any( ):
        factors.pop(argmax(pvals))
      else:
        break
    return factors
  ***
  # prune preselected factors based on in sample pvalue
  starting_factors = select_factors_based_on_pval(v, preselected_factors,
```

0.05)

```
***
  # add more factors based on out of sample cross-validation
  base_cv_scores = cross_validation(v, starting_factors)
  remaining_factors = set(factors) − set(starting_factors)
  valid_factors = starting_factors
  for remaining_factor in remaining_factors:
    factors_to_test = valid_factors + remaining_factor
    selected_factors = select_factors_based_on_pval(v, factors_to_test,
```

0.05)

if remaining_factor in selected_factors: # if the remaining factor being

tested survies the in-sample test

```
      cv_scores = cross_validation(v, factors_to_test)
      if wilcoxon_test(cv_scores − base_cv_scores) > 0.05: # then check if
```

it survives out of sample test

```
        valid_factors.append(remaining_factor)
        base_cv_scores = cv_scores
  return valid_factors.
```

It is possible that the foregoing portion of the methodology provides results that are suboptimal and/or are affected by excessive noise relative to predetermined performance criteria. In such a case, an alternative methodology is used, in which the methodology uses Ridge Regression to systematically evaluate all possible combinations of factors from the total factor set, optimize the ridge regularization parameter for each combination, and select the factor combination that achieves the highest objective function score.

A Non-Limiting Example of Pseudocode Outlining this is Presented Below:

```
def regress(ts, factors):
  # e.g., for a three factor model (f1, f2, f3), there are 7 combinations
  # (f1), (f2), (f3), (f1, f2), (f1, f3), (f2, f3), (f1, f2, f3)
  num combinations = 2 ** len(factors)
  ***
  # divide the combinations if the number of combinations is too big (by
```

default > 4096 combinations)

```
  N = 64
  CAPACITY = 4096
  ***
  if (N * CAPACITY) < num_combinations:
        n_group = N
  else:
        n_group = np.ceil(num_combinations / CAPACITY)
  if n_group == 1:
        score, selected_factors, ridge_lambda =
```

ridge_combination_optimization(ts, ( ), factors)

```
  else:
        NF = np.log2(N)
        combinations = list(itertools.product([0, 1], repeat=NF))
        results = [AWS_lambda_ridge_combination_optimization(ts,
```

combination, factors) for combination in combinations]

```
        results.sort(reverse=True)
        score, selected_factors, ridge_lambda = results[0]
  return score, selected_factors, ridge_lambda
***
def objective_function(alpha, X, y):
  # evaluate the result
  return score
***
def ridge_regression(X, y, alpha):
  n, m = X.shape
  I = np.eye(m)
  X_transpose = X.T
  ridge_term = alpha * I
  beta = np.linalg.inv(X_transpose @ X + ridge_term) @ X_transpose @ y
  return beta
  ***
def ridge_combination_optimization(ts, combination, factors):
  NR = len(factors) − len(combination)
  combs = list(itertools.product([0, 1], repeat=NR))
  best_score = 0
  best_selected_factors = ( )
  best_ridge_lambda = 0
  for comb in combs:
    all_comb = combination + comb
    selected_factors = factors[all_comb]
    initial_alpha = 0.1
    result = minimize(objective_function, initial_alpha, args=(X, y),
```

bounds=[(0, 1)])

```
    alpha, score = result.x[0], result.fun
    if score > best_score:
      best_score = score
      best_selected_factors = selected_factors
      best_ridge_lambda = alpha
  return best_score, best_selected_factors, best_ridge_lambda
***
def AWS_lambda_ridge_combination_optimization(ts, combination, factors):
  # calling ridge_combination_optimization(ts, combination, factors) on
```

AWS lambda

return best_score, best_selected_factors, best_ridge_lambda.

Computing all possible combinations may be infeasible without a horizontally scalable computational architecture and algorithm. To achieve this, it may be beneficial to leverage a third-party service such by way of non-limiting example AWS Lambda to host worker computation processes, enabling horizontal scalability, and AWS S3 and ElasticCache for inter-process caching, facilitating the sharing of pre-computed matrix decomposition values (specifically, singular value decomposition of the factor variance/covariance matrix) among all workers.

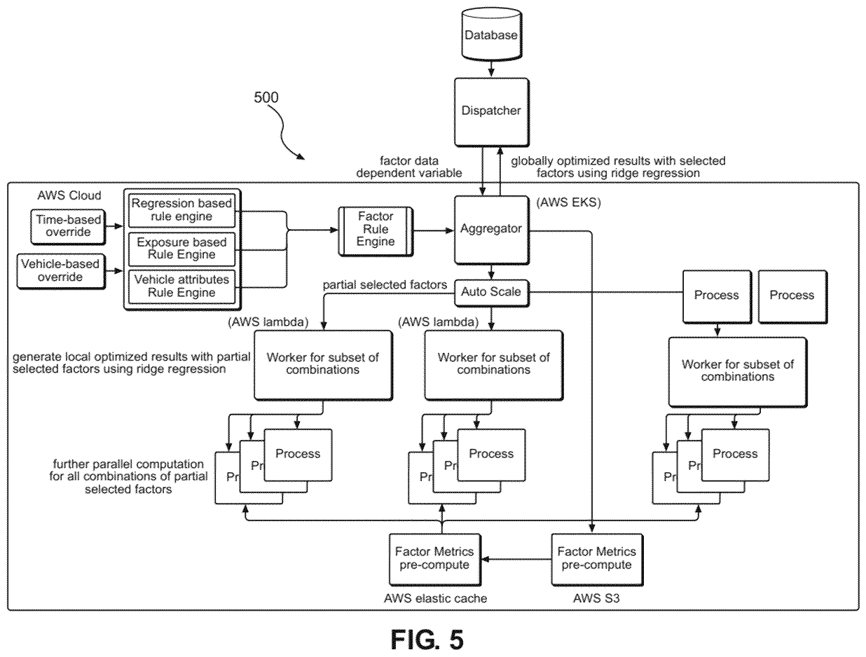

The methodology deploys an Aggregator on AWS EKS to serve as the controller for the map-reduce process during regression analysis, for which the workflow is shown at 500 in FIG. 5. To expedite computation, the methodology pre-computes matrix decomposition values of factor variance/covariance matrices, storing these pre-computed values in AWS S3. These values are subsequently loaded into AWS ElasticCache, allowing all workers to access them. The pre-computation process can be scheduled on a monthly or quarterly basis, aligned with the factor variance/covariance matrix recalibration schedule.

As illustrated in the pseudocode, the Aggregator configures the capacity for each worker and divides the overall regression process into multiple chunks, utilizing AWS Auto Scaling to distribute the workload across numerous workers. In this setup, AWS Lambda serves as a scalable, pay-as-you-go computation platform. Each worker is assigned factors divided into two categories: “defined” factors and “to-be-selected” factors. The process of generating the ‘defined’ factors as shown in FIG. 5, using multiple rule engines, and allow people to override the ‘defined’ values. The process first uses vehicle attributes, e.g., whether a Fixed Income vehicle or Equity vehicle, and filter the total factors to get the set of ‘defined’ factors, then based on the exposure information, e.g., whether the vehicle with large exposure to certain financial sectors, and add or remove factors from the defined set, then apply a small OLS regression model to further filter regional factors. In some instances, the process allows model admin to directly override the set of ‘defined’ factors. For instance, in a 20-factor model, the methodology designates the first four factors as the “defined” factor set, with the remaining factors as the “to-be-selected” set. This requires 16 workers, each handling a specific combination of the defined factor set (a total of 2\hat{ }4=16 combinations). For each combination of “defined” factors, the worker identifies the optimal “to-be-selected” factors for its assigned combination. Finally, at the Aggregator node, the global best factor set for regression is selected. This approach enables ridge regression with coefficient optimization and factor selection, leveraging parallel computation power on the public cloud.

Once the relevant factors are identified, the methodology can estimate the Betas and Alphas, which correspond to the systematic and residual components, respectively, as known in the art. The systematic component measures the contribution attributable to the market, while the residual component represents the portion that cannot be explained by market movements. An important observation is that if the true beta is used to compute the market component, the residual returns and market returns will be uncorrelated by design.

The methodology can enhance the Ordinary Least Squares (OLS) regression with two adjustments.

The first adjustment is Weighted Least Squares (WLS). Given the forward-looking nature of the model, the methodology assign greater weights to more recent data points, with weights decaying exponentially backward in time. This approach enables the model to be more responsive to recent trends.

The second adjustment is Ridge Regression. To address the potential instability of beta estimates due to collinearity among factors, the methodology applies a Ridge penalty. This technique helps shrink the variance of beta, leading to more stable and reliable estimates.

The Methodology Fits the Model with Standardized Returns:

$${\hat{B}}_{S} = {arg min}_{{β}_{S}} {( {Y}_{S} - {X}_{S} {β}_{S} )}^{T} W ( {Y}_{S} - {X}_{S} {β}_{S} ) + {λ}^{2} ( {w}^{T} w ) ( {β}_{S}^{T} {β}_{S} ) = {( {X}_{S}^{T} {WX}_{S} + {λ}^{2} ( {w}^{T} w ) I )}^{- 1} ( {X}_{S}^{T} {WY}_{S} )$$

Where, W=diag(w12, w22, . . . , wn2) and I is the identity matrix;
Y: n×1 vector representing the vehicle returns;
X: n×k matrix representing the factor returns;
w: n×1 vector representing the weights, wi=2−(n−i)/η, where η is the half-life of the decay process in months. By way of non-limiting example, η=24 (2 years) for hedge funds and η=36 (3 years) for other vehicles;
λ2: The Ridge penalty. Using the square notion allows λ to be on the same scale as weights and volatilities;
Ys: n×1 vector, the standardized vehicle returns, =(Y−JY̅)/σY, where Y̅ and σY are estimated with simple sample mean and sample standard deviation, and J is a n×1 vector of all 1s.
Xs: n×k matrix, the standardized factor returns, =(X−JX̅)/(JσX), where:
X̅: 1×k vector with each element being the sample mean of each factor's returns, or each column of X; and
σX: 1×k vector with each element being the volatility estimate of each factor.
   Finally, we have:

$$\hat{B} = σ Y \hat{β} s . / σ X$$

$$\hat{α} = \overline{Y} - \overline{X β}$$

### Where:

σY: Standard deviation of vehicle returns. It is used to scale the standardized beta coefficients back to the original scale of the data.
β's: Vector of standardized beta coefficients.
\hat{α}: Estimated intercept term of the regression model.
Y̅: Mean of the vehicle returns.
X̅: 1×k vector of means for each of the factor returns.
β: Vector of estimated beta coefficients for the non-standardized factor returns, as calculated in the first equation.

As noted above, the second overall step of the methodology is capturing transient factor signals and time-varying asset exposures through temporal cross-validation. The methodology forecasts alpha using a structured temporal approach. Once returns up to time t are available, the methodology generates forecasts for the subsequent period, which may suffice for the next few quarters. The methodology may rely exclusively on information available up to time t for these forecasts, even though additional monthly data may become available later, although the invention is not so limited.

To evaluate the out-of-sample (OoS) performance of forecasts, the methodology employs a rolling-window strategy. This involves calculating performance metrics such as the root mean squared error and OoS r-squared over rolling blocks of observations, or sub-samples, from the entire sample period, of which 72 rolling blocks is a non-limiting example. The initial sub-sample may span three years, and each subsequent sub-sample shifts forward by one month, quarter, or any other another chosen period. In other words, the methodologies' alpha estimation uses a rolling three-year training window to re-fit the model, with the subsequent period serving as the testing data. For this non-limiting example, this results in a sequence of 37 values for each OoS performance metric, allowing the methodology to assess and compare forecast performance across different methods and predictor sets.

The methodology may require at least n data points to be effective depending on the period. If the time series is only slightly more than n data points, the test data may be insufficiently reliable. For instance, if only 50 months of returns are available, only 4 quarterly data points exist to estimate the prediction error. To address this limitation, the methodology may employ Leave-One-Out Cross Validation (LOOCV) as a secondary method. In LOOCV, the methodology leaves one data point out as the testing data and re-fit the model using Weighted Least Squares (WLS) regression with the remaining n−1 data points. This process is repeated for each of the n data points, and the root mean square (RMSE) of all error terms provides the LOOCV prediction error estimate PEloocv.

Finally, the Methodology Combines these Estimates Using a Weighted Approach:

$$P \hat{E} = φ P \hat{Er} olling + ( 1 - φ ) P \hat{E} loocv$$

### Where:

PE: Final estimated prediction error. It is a weighted combination of the prediction errors obtained from the Rolling method and the LOOCV method.
φ: max (m/12,0)—Weighting factor that determines the relative importance of the rolling method versus the LOOCV method.
m: Number of rolling regressions that can be performed given the data availability.
PErolling: Prediction error estimated using the rolling method. It represents the root mean squared error (RMSE) of the model's predictions over a series of rolling windows.
PEloocv: Prediction error estimated using the Leave-one-out-cross-validation (LOOCV) method.

The rationale behind this mixing methodology is that as the track record of the asset lengthens, increasing trust is placed on the rolling method. By way of non-limiting example, when (n<39), the methodology relies solely on LOOCV, as the rolling method may not be feasible. For assets with six years or more of returns, which is common, the methodology may rely exclusively on the rolling method.

A Non-Limiting Example of the Pseudocode Outlining this is as Follows:

```
def temporal_cross_validation(v, selected_factors, period):
  loop while_period_is_valid:
  training = v.get_training_data(start_dt, end_dt)
  v.model = ridge_regression_w_hyper_param_optimization(training)
  predictions = v.model.predictions( )
  perf_metrics = compare_predictions(predictions, actual)
  v.metrics = collate(perf metrics)
  advance_period
  return score(v.metrics)
  ***
# Final regression
  betas = v.final_model(v, factors)
  ate = v.temporal_cross_validation(v, factors, period)
```

In addition, the methodology produces estimates with low bias while addressing the challenge of increasing variance found in regression models as the number of covariates grows. To enhance prediction accuracy and reduce overfitting, the methodology manages the variance of the estimates. The methodology addresses this issue by using Ridge regression, which includes a penalty term that imposes shrinkage by incorporating a penalty term inspired by the Bayesian Information Criterion (BIC) approach, which penalizes the number of factors selected in the model. The methodology modifies the BIC approach to exempt factors marked as “Prefer” in the Pre-Selection process from this penalty.

### A Non-Limiting Example of a Model Score Function is:

$$Mscore = n \cdot ln ( σ \hat{ε2} ) + ( k 1 ) \cdot ln ( n )$$

### Where:

k1: The number of factors marked as Neutral but included in the model.
n: Number of training data points.
ln(σε\hat{2}): Natural logarithm of the estimated prediction error variance. The prediction error variance measures how well the model's predictions match the actual data. A lower variance indicates better predictive accuracy.

To identify the best model, the methodology may evaluate a subset of models among all 2\hat{ }p possible combinations and selects the one with the lowest Mscore. The methodology may employ the Best Subsets approach, which evaluates all 2\hat{ }p possibilities. In other cases, the methodology provides for hyperparameter tuning on the lambda, which controls the degree of shrinkage through cross-validation to minimize the out-of-sample error, ensuring the model is optimally tuned for predictive performance.

As discussed above, the third overall step is enhancing the accuracy of correlation estimates by incorporating dynamic conditional correlation. Thus, once the optimal model is selected, the dynamic relationships between multiple financial time series is accounted for using Dynamic Conditional Correlation (DCC) models. Dynamic conditional correlation (DCC) estimators have the flexibility of univariate Generalized Autoregressive Conditional Heteroskedasticity (GARCH) but not the complexity of conventional multivariate GARCH.

These models, which parameterize the conditional correlations directly, are naturally estimated in two steps—a series of univariate GARCH estimates and the correlation estimate.

These methods are superior to multivariate GARCH models in that the number of parameters to be estimated in the correlation process is independent of the number of series to be correlated. Thus, potentially very large correlation matrices can be estimated.

Consider n time series of returns and make the industry norm assumption that returns are serially uncorrelated. Then, we can define a vector of zero-mean white noises as:
ϵt=rt−μ, where rt is the n×1 vector of returns and μ is the vector of expected returns.
   Despite being Serially Uncorrelated, the Returns May Present Contemporaneous Correlation. That is, Σt:=Et−1[(rt−μ)(rt−μ)′] May not be a Diagonal Matrix, where:
Σt: Conditional covariance matrix at time (t). It represents the expected covariance of the returns at time (t) given the information available up to time (t−1).
Et−1: Conditional expectation operator, which calculates the expected value of a random variable given the information available up to time (t−1).
rt: Vector of returns at time (t). Each element of the vector corresponds to the return of a factor.
μ: Vector of expected returns. It represents the mean return for factor.

Moreover, this contemporaneous variance may be time-varying, depending on past information.

The methodology forecasts the correlation matrix for the short-term period, as defined by a predetermined time period, by applying Dynamic Conditional Correlation (DCC) model. DCC calculates the current correlation between variables of interest as a function of past realizations of both the volatility within the variables and the correlations between them.

Thus, the relationship between variables can be seen to evolve over time in a manner that not only depends upon whether and to what degree the variables are moving in the same direction, but also takes account of the history of variance that each series has undergone.

$${ρ}_{t} = \frac{{q}_{1 , 2 , t}}{\sqrt{{q}_{1 , 1 , t} {q}_{2 , 2 , t}}} , where$$

$${q}_{i , j , t} = ( 1 - λ ) ( {ε}_{i , t - 1} {ε}_{j , t - 1} ) + λ ( {q}_{i , j , t - 1 )} .$$

### Where:

ρₜ: Element of the conditional correlation matrix at time (t).
q_{i,j,t}: Element of the conditional covariance matrix at time (t), representing the covariance between the i^{th} and j^{th} variables.
λ: This is a smoothing parameter that determines the weight given to past observations in the calculation of the conditional covariance. It typically ranges between 0 and 1.
ε_{i,t-1}, ε_{j,t-1}: standardized residuals for the i^{th} and j^{th} variables at time (t−1). Standardized residuals are obtained by dividing the residuals by their conditional standard deviations.

### The Calculation of DCC May Involve Three Stages:

The first stage accounts for the conditional heteroscedasticity. It includes estimating, for each one of the n series of returns rti, its conditional volatility σti using a GARCH model. Let Dt be a diagonal matrix with these conditional volatilities, i.e. Dti,i=σti and if i≠j, Dti,i=0. Then the standardized residuals are vt:=Dt−1(rt−μ), and notice that these standardized residuals have unit conditional volatility. Now, the methodology defines the matrix:

$$R := \frac{1}{T} {\sum }_{t = 1}^{T} {v}_{t} {v}_{t}^{′} .$$

### Where:

R: Constant conditional correlation (CCC) matrix, as proposed by Bollerslev (1990). It represents the average correlation between the standardized residuals over the entire sample period.
T: This is the total number of time periods in the sample. It represents the length of the time series data used to calculate the CCC matrix.
vₜ: Vector of standardized residuals at time (t). Each element of vₜ is the residual of a return series divided by its conditional standard deviation, which is estimated using a GARCH model. Standardized residuals have a mean of zero and a unit variance.

This is the Bollerslev's Constant Conditional Correlation (CCC) Estimator. The estimation of one GARCH model for each of the n time series of returns is standard. The methodologies for both are known in the art and not further detailed herein.

The next step includes generalizing Bollerslev's CCC to capture dynamics in the correlation, hence the name Dynamic Conditional Correlation (DCC). The DCC correlations are:

$${Q}_{\text{?}} = \overline{R} + α ( {v}_{t - 1} {v}_{t - 1}^{′} - \overline{R} ) + β ( {Q}_{t - 1} - \overline{R} ) .$$

$$\text{?} \text{indicates text missing or illegible when filed}$$

### Where:

R: This is the constant conditional correlation matrix, as calculated in step 1. It serves as the long-term average correlation matrix.
α: A parameter that determines the weight given to the most recent observation of the outer product of standardized residuals in updating the conditional covariance matrix. It captures the short-term dynamics in the correlation.
vt−1: Vector of standardized residuals at time (t−1).
β: A parameter that determines the weight given to the previous conditional covariance matrix Qt−1 in updating the current matrix Qt. It captures the persistence in the correlation dynamics.
Qt−1: Conditional covariance matrix at time (t−1).

So, Qti,j is the correlation between rti and rtj at time t. The methodology estimates both parameters, α and β, simultaneously, by maximizing the log likelihood. The standardized residuals are assumed to be jointly Gaussian. To reduce the computation cost and electrical power needs of estimating a vast dimensional time-varying correlation model, the methodology uses a technique called Composite Likelihood.

The third stage is forming a correlation matrix and a covariance matrix, which are expected to be positive definite.

For the calculation of variance-covariance matrix of factors the methodology compares different methods, based on the robustness of predictive power. Compared with out-of-sample realized monthly volatility, EWMA may be the most stable and straight-forward method in terms of parameter stability and forecasted RSQ measures. An exponential weighting puts more weight on the more recent observations. With smoothing constant λ an n-period EWMA of a time series is defined as:

$${σ}_{\text{?}}^{2} = \frac{{\sum }_{\text{?}}^{\text{?}} {λ}^{\text{?}} {R}_{\text{?}}^{2}}{1 + λ + {λ}^{2} + K + {λ}^{m - 1}} where 0 < λ < 1$$

$$\text{?} \text{indicates text missing or illegible when filed}$$

### Where:

$${σ}_{\text{?}}^{2} :$$

$$\text{?} \text{indicates text missing or illegible when filed}$$

estimated variance at time (t+1).
λ: Smoothing parameter, also known as the decay factor. It determines the weight given to past observations in the calculation of the variance.
R2t+1: Squared return at time (t+1).
st2 is population variance, we convert it to sample variance by

$${S}^{2} + {σ}_{t}^{2} \frac{n}{n - 1}$$

### Where:

n: is the number of observations.
σ²ₜ: estimated variance at time (t).

The larger the value of λ, the more weight is placed on past observations and so the series becomes smoother. Risk Metrics may use by way of non-limiting example lambda=0.94 for daily volatility and 0.97 for monthly volatility forecasting.

Denominator converges to 1/(1−λ) as n goes to ∞.

$$\begin{matrix}{σ}_{\text{?} + 1}^{2} = ( 1 - λ ) {\sum }_{\text{?} = 1}^{∞} {λ}^{\text{?}} {R}_{\text{?}}^{2} \\ = ( 1 - λ ) {\sum }_{\text{?} = 2}^{∞} {λ}^{\text{?}} {R}_{\text{?}}^{2} + ( 1 - λ ) {R}_{\text{?}}^{2} \\ = {λσ}_{\text{?}}^{2} + ( 1 - λ ) {R}_{\text{?}}^{2}\end{matrix}$$

$$\text{?} \text{indicates text missing or illegible when filed}$$

### Where:

σ²ₜ: estimated variance at time (t).
λ: Smoothing parameter, also known as the decay factor. It determines the weight given to past observations in the calculation of the variance.
R2t: Squared return at time (t).

So intuitively, tomorrow's volatility is the weighted average of today's predicated volatility and realized volatility.

### Below is a Non-Limiting Example of Pseudo Code for Generating the DCC Correlation Matrix:

### Step 1—Load Factor Returns Data and Standardize the Returns.

Rstd=R−Mean(R)

### Step 2—Generate Dynamic Conditional Correlation Matrix for Factors.

$$Q = zeroes ( t , k )$$

$$For i = 1 : k$$

Parameters=[parameters; univariate {i}.parameters]

$$Q ( : , i ) = univariate \{ i \} . ht ;$$

Where, univariate {i}.ht is the conditional (time-varying) variance of asset i.

$$Qstd = Q {.}^{⋀} ( 0.5 )$$

$$For i = 1 : t$$

$$Qt ( : , : , i ) = diag ( Qstd ( i , : ) ) * Rt ( : , : , i ) * diag ( Qstd ( i , : ) ) ;$$

Where, Qt is the Dynamic Conditional Correlation Matrix.

### Step 3—Calculate Residuals.

$$For i = 1 : t$$

$$stdresid ( i , : ) = data ( i , : ) * {Qt ( : , : , i )}^{⋀} ( - 0.5 ) ;$$

$$resid = {stdresid ( end , : )}^{′} * stdresid ( end , : )$$

Step 4—Convert the Correlation Matrix into Forecasted Correlation Matrix Using EWMA.

$$Rt = Qt ( : , : , end ) . / ( sqrt ( diag ( Qt ( : , : , end ) ) ) * {sqrt ( diag ( Qt ( : , : , end ) ) )}^{′} ) ;$$

Where, Rt is the Forecasted Correlation matrix . . . .

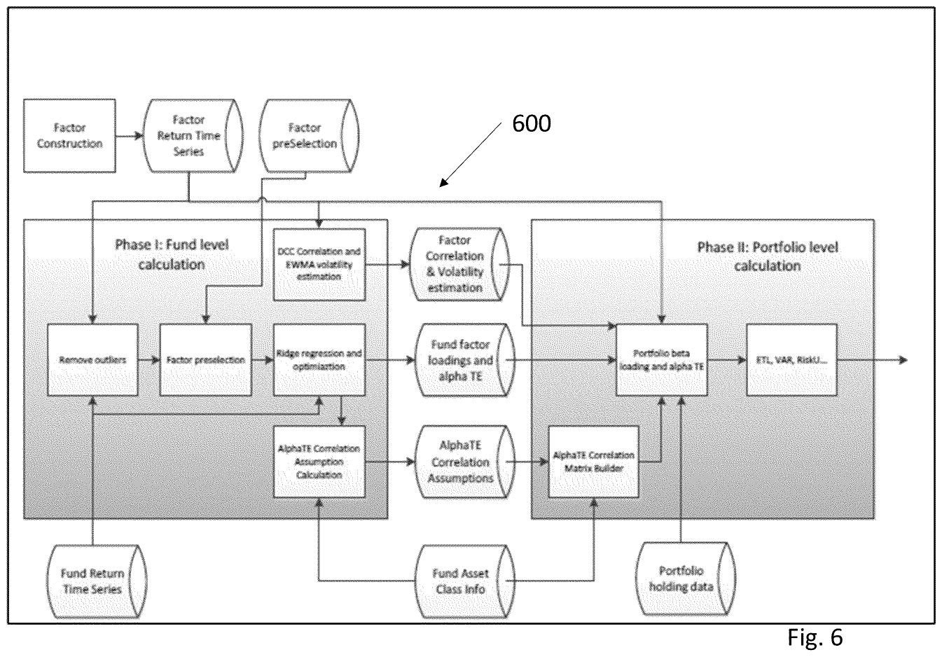

Referring now to FIG. 6, an embodiment of a workflow is shown for a beta model forecasting methodology. The model has two phases, with phase I computing fund level factor loadings and phase II computing portfolio factor level loadings.

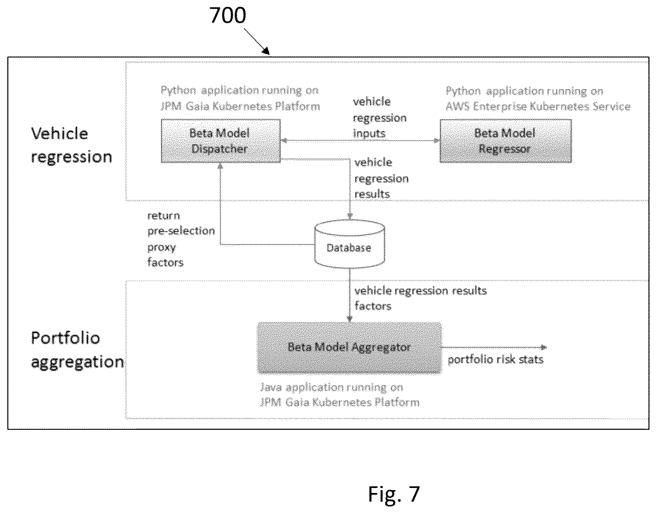

Referring now to FIG. 7, an embodiment of a workflow is shown for a python development framework consistent with the above functionality.

As noted above, the total factor universe considered by the methodology may be 32 factors. A non-limiting example of such 32 factors is as follows:
SP500 value.
MSCI Europe value.
MSCI Japan value.
MSCI EM value.
Small-large.
Value-Growth.
Liquidity
Equity yield.
Quality of asset (relative to predetermined criteria).
Momentum of asset.
Volatility index value.
Inflation rate.
Ten-year yield rate.
Muni ten-year spread.
German spread.
2-10 spread.
High yield Option Adjusted Spread.
Dollar.
Commodity prices.
Merger Arb.
Macro Trend.
Utilities.
Information Technology.
Real Estate.
Materials.
Industrials.
Health Care.
Financials.
Energy.
Consumer Staples.
Consumer Discretionary.
Communication Services.

By utilizing the elements outlined, the methodology can effectively combine both factor-related and idiosyncratic risks to support forecasting portfolio volatility. Portfolio risk is aggregated as a combination of these two components: factor-related risk and specific risk.

Factor-related risk is derived from the asset's exposure to each factor, the volatility of these factors, and the correlations between them. The methodology underscores the impact of robustly measuring asset volatilities and correlations to achieve an accurate evaluation of portfolio risk. Since these factors are common across all assets within our universe, they provide a cohesive framework for risk contribution.

A portfolio's risk may be calculated by a combination of an asset's exposure to a given factor, the inherent risk of the factor, and the correlation between that factor and others. In addition, there exists a component of risk not captured by the factors, known as the residual risk. These residuals could represent additional granular factors that are not accounted for by the core factors, so the methodology may incorporate an additional term that captures the covariances between the residual risks of the different assets known as portfolio's Alpha Tracking Error (AlphaTE). ATE is calculated based on asset's AlphaTE and the correlation of the asset's Alpha TEs. The methodology may use an assumption to represent asset's correlations by using the correlations of their top-level asset class. The correlation matrix closely follows some market statistics and realistically represents correlation among two assets.

The asset class correlation matrix is calculated by examining correlations of representative asset's AlphaTE based on period of return series time, which by way of non-limiting example and further explanation is 6 years of return time series, which are recalibrated every few years. In the context of a diversified portfolio, these residuals should often diversify away. Conversely, for a portfolio with more active risk, the methodology can examine risk under the same lens through a similar approach via tracking error.

### Portfolio Volatility, is Calculated Using the Expression

$${σ}_{P}^{2} = w ( Λ = B \sum {B}^{T} ) {w}^{T}$$

In this formula, w is the vector of portfolio weights, Λ is the alpha risk covariance matrix, B is the matrix of beta estimates, and Σ is the covariance matrix of factor returns. Breaking this down further, the components are

$$w = [ {w}_{1} , {w}_{2 ,} … , {w}_{n} ]$$

$$B = [ \begin{matrix}{β}_{11} & {β}_{12} & … & {β}_{1 p} \\ {β}_{21} & {β}_{22} & … & {β}_{2 p} \\ ⋮ & ⋮ & ⋱ & ⋮ \\ {β}_{n 1} & {β}_{n 2} & … & {β}_{np}\end{matrix} ]$$

$$α = [ {α}_{1} , {α}_{2 ,} … , {α}_{n} ]$$

$$Λ = [ \begin{matrix}{α}_{1}^{2} & {ρ}_{12} {α}_{1} {α}_{2} & … & {ρ}_{1 n} {α}_{1} {α}_{n} \\ {ρ}_{21} {α}_{2} {α}_{1} & α \frac{2}{2} & … & {ρ}_{2 n} {α}_{2} {α}_{n} \\ ⋮ & ⋮ & ⋱ & ⋮ \\ {ρ}_{21} {α}_{2} {α}_{1} & {ρ}_{21} {α}_{2} {α}_{1} & … & {α}_{n}^{2}\end{matrix} ]$$

where:
ω is the 1×n vector of asset weights in the portfolio.
B is the n×p matrix of beta estimates for the n assets against the p factors.
β_ij is the sensitivity of the i^{th} asset to the j^{th} factor.
α is the 1×n vector of alpha risk for the n assets, which is estimated from the out-of-sample quarterly alpha risk.
Λ is the n×n alpha risk covariance matrix.
ρ_ij is the AlphaTE correlation between two assets. If two assets belong to different top asset classes, we use the top-level matrix to define the AlphaTE correlation, if they belong to the same top asset class, based on their sub-class, we use the second level matrix to define the AlphaTE correlation.
n is the number of assets in the portfolio.
p is the number of factors.

### Tracking Error (TE) Between a Portfolio and its Benchmark, is Calculated Using the Expression

$$TE = \sqrt{{\sum }_{i} {\sum }_{j} {Beta}_{i}^{Diff} * {Beta}_{j}^{Diff} * Covariance ( ij ) + {( {Alpha}^{Diff} )}^{2}}$$

$${Beta}^{Diff} = {Beta}^{Portfolio} - {Beta}^{Benchmark}$$

$${Alpha}^{Diff} = \sqrt{\begin{matrix}{( {Alpha}^{Portfolio} )}^{2} - {( {Alpha}^{Benchmark} )}^{2} - 2 * \\ ρ * {Alpha}^{Portfolio} * {Alpha}^{Benchmark}\end{matrix}} = ATE ( Portfolio - Benchmark )$$

where
ρ is the alpha risk correlation between Portfolio and Benchmark, which can be calculated based on the Alpha Tracking Error correlation assumption discussed previously. The formula is essentially equivalent to calculating the Alpha TE of (Portfolio-Benchmark), consider (Portfolio-Benchmark) as a delta portfolio with positive allocation of the original Portfolio and corresponding negative allocation of the Benchmark.

Once factor sensitivities are estimated, the fund projected volatility is calculated as a volatility of a portfolio of factors, where sensitivities are used as “weights” of factors in the portfolio. The “alpha” risk is added back with the assumption of orthogonality with the beta factors.

### Alpha Tracking Error of a Portfolio, is Calculated Using the Expression

$$ATE = \sqrt[2]{{\sum }_{i = 1}^{N} {\sum }_{j = 1}^{N} {ω}_{i} {α}_{i} {corr}_{ate} ( i , j ) {α}_{j} {ω}_{j}}$$

$$The Formula for Correlation Is$$

$$r = \frac{\sum ( X - \overline{X} ) ( Y - \overline{Y} )}{\sqrt{\sum {( X - \overline{X} )}^{2}} \sqrt{{( Y - \overline{Y} )}^{2}}}$$

where
X, Y are from monthly returns of last 60 months while X⁻, Y⁻ are averages.

In some embodiments as disclosed above in FIGS. 1-7, technical improvements effected by the instant disclosure may include a platform for implementing the noted functionality, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for forecasting an asset's volatility based on a low number of factors, comprising:
identifying a factor subset of a total factor set, comprising:
preselecting factors from the total factor set based on known attributes of the asset;
determining exposure for each of the preselected factors, the exposures defining an influence of each of the preselected factors on performance of the asset;
pruning factors for which the determined exposures fail to satisfy first predetermined criteria;
adding other factors, from the total factor set to the factor subset, that improve performance of the asset;
first applying temporal cross validation to at least the factor subset;
second applying dynamic conditional correlation to factor returns of the total factor set; and
forecasting the asset's volatility based on results of the first applying and the second applying.

2. The method of claim 1, wherein the determining exposures for each of the preselected factors comprises:
applying ordinary least squares (OLS) regression on the preselected factors to indicate which of the preselected factors have a strongest relationship with performance of the asset.

3. The method of claim 1, wherein the adding comprises:
establishing a baseline performance of the factor subset;
selecting a new factor from remaining ones of the total factor set;
determining whether a performance effect of the new factor relative to the baseline performance meets second predetermined criteria;
incorporating, in response to at least a positive result of the determining, the new factor into the factor subset; and
returning to the selecting until the total factor set is empty.

4. The method of claim 3, further comprising between the incorporating and the returning:
adjusting the baseline performance to account for the performance of the factor subset after the incorporating.

5. The method of claim 1, further comprising:
determining whether results of the identifying are either suboptimal or affected by excessive noise per third predetermined criteria;
in response to at least a positive result of the determining:
applying ridge regression to evaluate all possible combinations of factors from the total factor set;
optimizing a ridge regularization parameter for each combination; and
selecting as the factor subset a combination of factors from the total factor set that achieves a highest objective function score.

6. The method of claim 1, wherein the applying dynamic conditional correlation comprises:
estimating, for each one of n series of returns, a conditional volatility using a Generalized Autoregressive Conditional Heteroskedasticity model;
generating a dynamic conditional correlation matrix for the factor returns; and
converting the dynamic conditional correlation matrix into a forecasted correlation matrix.

7. The method of claim 1, wherein the preselected factors are based on a region, sector, style, size, names, and/or a valuation metric of the asset.

8. A system for forecasting an asset based on a low number of factors, comprising:
a processor;
a memory storing instructions programmed to cooperate with the processor to cause the processor to perform operations comprising:
identifying a factor subset of a total factor set, comprising:
preselecting factors from the total factor set based on known attributes of the asset;
determining exposure for each of the preselected factors, the exposures defining an influence of each of the preselected factors on performance of the asset;
pruning factors for which the determined exposures fail to satisfy first predetermined criteria;
adding other factors, from the total factor set to the factor subset, that improve performance of the asset;
first applying temporal cross validation to at least the factor subset;
second applying dynamic conditional correlation to factor returns of the total factor set; and
forecasting the asset's volatility based on results of the first applying and the second applying.

9. The system of claim 8, wherein the determining exposures for each of the preselected factors comprises:
applying ordinary least squares (OLS) regression on the preselected factors to indicate which of the preselected factors have a strongest relationship with performance of the asset.

10. The system of claim 8, wherein the adding comprises:
establishing a baseline performance of the factor subset;
selecting a new factor from remaining ones of the total factor set;
determining whether a performance effect of the new factor relative to the baseline performance meets second predetermined criteria;
incorporating, in response to at least a positive result of the determining, the new factor into the factor subset; and
returning to the selecting until the total factor set is empty.

11. The system of claim 10, the operations further comprising between the incorporating and the returning:
adjusting the baseline performance to account for the performance of the factor subset after the incorporating.

12. The system of claim 8, the operations further comprising:
determining whether results of the identifying are either suboptimal or affected by excessive noise per third predetermined criteria;
in response to at least a positive result of the determining:
applying ridge regression to evaluate all possible combinations of factors from the total factor set;
optimizing a ridge regularization parameter for each combination; and
selecting as the factor subset a combination of factors from the total factor set that achieves a highest objective function score.

13. The system of claim 8, wherein the applying dynamic conditional correlation comprises:
estimating, for each one of n series of returns, a conditional volatility using a Generalized Autoregressive Conditional Heteroskedasticity model;
generating a dynamic conditional correlation matrix for the factor returns; and
converting the dynamic conditional correlation matrix into a forecasted correlation matrix.

14. The system of claim 8, wherein the preselected factors are based on a region, sector, style, a size, names and/or a valuation metric of the asset.

15. A non-transitory computer readable media storing instructions programmed to cooperate with a processor to cause the processor to perform operations for forecasting an asset based on a low number of factors, the operations comprising:
identifying a factor subset of a total factor set, comprising:
preselecting factors from the total factor set based on known attributes of the asset;
determining exposure for each of the preselected factors, the exposures defining an influence of each of the preselected factors on performance of the asset;
pruning factors for which the determined exposures fail to satisfy first predetermined criteria;
adding other factors, from the total factor set to the factor subset, that improve performance of the asset;
applying temporal cross validation to at least the factor subset; and
applying dynamic conditional correlation to factor returns of the total factor set; and
forecasting the asset's volatility based on results of the first applying and the second applying.

16. The non-transitory computer readable media of claim 15, wherein the determining exposures for each of the preselected factors comprises:
applying ordinary least squares (OLS) regression on the preselected factors to indicate which of the preselected factors have a strongest relationship with performance of the asset.

17. The non-transitory computer readable media of claim 15, wherein the adding comprises:
establishing a baseline performance of the factor subset;
selecting a new factor from remaining ones of the total factor set;
determining whether a performance effect of the new factor relative to the baseline performance meets second predetermined criteria;
incorporating, in response to at least a positive result of the determining, the new factor into the factor subset; and
returning to the selecting until the total factor set is empty.

18. The non-transitory computer readable media of claim 17, the operations further comprising between the incorporating and the returning:
adjusting the baseline performance to account for the performance of the factor subset after the incorporating.

19. The non-transitory computer readable media of claim 15, the operations further comprising:
determining whether results of the identifying are either suboptimal or affected by excessive noise per third predetermined criteria;
in response to at least a positive result of the determining:
applying ridge regression to evaluate all possible combinations of factors from the total factor set;
optimizing a ridge regularization parameter for each combination; and
selecting as the factor subset a combination of factors from the total factor set that achieves a highest objective function score.

20. The non-transitory computer readable media of claim 15, wherein the applying dynamic conditional correlation comprises:
estimating, for each one of n series of returns, a conditional volatility using a Generalized Autoregressive Conditional Heteroskedasticity model;
generating a dynamic conditional correlation matrix for the factor returns; and
converting the dynamic conditional correlation matrix into a forecasted correlation matrix.
